(19) United States
(12) Patent Application Publication
(10) Pub. No.: US 2021/0160079 A1
(43) Pub. Date: May 27, 2021

(54) WEARABLE SMART TERMINAL, CLOUD SERVER, MEMORY DEVICE AND FRIEND ADDITION METHOD

(71) Applicant: JRD Communication (Shenzhen) Ltd., Shenzhen City (CN)

(72) Inventor: Peng Zeng, Shenzhen City (CN)

(21) Appl. No.: 16/610,717

(22) PCT Filed: May 30, 2018
(86) PCT No.: PCT/CN2018/088993

§ 371 Date: Nov. 4, 2019

(30) Foreign Application Priority Data
May 31, 2017 (CN) 201710401653.4

(51) Int. Cl. H04L 9/32; H04W 4/80; H04W 4/21; H04L 12/58

(52) U.S. Cl. CPC H04L 9/3242; H04W 4/80; H04L 9/3273; H04L 51/32; H04W 4/21

(57) ABSTRACT

A friend addition method for a wearable smart terminal, comprising: when a first wearable smart terminal receives a first request of a first user for adding a friend, starting a wireless signal search function; obtaining the media access control address of a second wearable smart terminal which is found within a preset time and which has a signal strength that is greater than a preset threshold; sending to a cloud server a second request for adding a second user of the second wearable smart terminal as a friend, the second request carrying a user identity of the first user and the media access control address of the second wearable smart terminal, so that the cloud server finds the user identity of the second user and sends to the second wearable smart terminal a third request of the first user for adding the second user as a friend.

### FIELD OF THE INVENTION

The present invention relates to a wearable smart terminal, and more particularly to a wearable smart terminal, a cloud server, a memory device, and a friending method of friending others.

### BACKGROUND

With the rapid development of kids smart watches, a kids smart watch now has more and more functions in addition to making a call. However, most of these functions are not creative. Especially, those functions do not provide any social networking services, such as friending others, for kids.

### SUMMARY

The technical issue that the embodiment of the present invention solves is to provide a wearable smart terminal, a cloud server, a memory device and a method of friending others, which could send a request for friending another person via the cloud.

In order to solve the above problem, an embodiment of the present invention provides a friending method of a wearable smart terminal, comprising: activating a wireless searching function in a condition that a first wearable smart terminal receives a first request for friending another person from a first user; obtaining a media access control address of the second wearable smart terminal in a condition that a wireless signal of a second wearable smart terminal is detected within a predetermined period of time to be stronger than a threshold voltage; and sending a second request for friending a second user of the second wearable smart terminal to a cloud server to allow the cloud server to find a user identification of the second user according to a corresponding relationship between media access control address information and user identification information such that the cloud server further sends a third request of the first user for friending the second user, wherein the second request carries a user identification of the first user and the media access control address of the second wearable smart terminal and the third request carries a user identification of the first user.

In order to solve the above problem, another embodiment of the present invention provides a wearable smart terminal, comprising a processor, communication circuit, and a display; wherein the processor is electrically coupled to the communication circuit and the display, the processor controls itself, the communication circuit and the display to perform the friending method above.

In order to solve the above problem, another embodiment of the present invention provides a memory device storing program instructions. This program instructions could be executed to perform following steps: activating a wireless searching function in a condition that a first wearable smart terminal receives a first request for friending another person from a first user; obtaining a media access control address of the second wearable smart terminal in a condition that a wireless signal of a second wearable smart terminal is detected within a predetermined period of time to be stronger than a threshold voltage; displaying a failure confirmation window to receive a confirmation information if no wireless signal stronger than the threshold value is detected within the predetermined period of time; sending a second request for friending a second user of the second wearable smart terminal to a cloud server to allow the cloud server to find a user identification of the second user according to a corresponding relationship between media access control address information and user identification information such that the cloud server further sends a third request of the first user for friending the second user, wherein the second request carries a user identification of the first user and the media access control address of the second wearable smart terminal and the third request carries a user identification of the first user; wherein the wireless signal searching function is a Bluetooth signal searching function, and the media access control address of the second wearable smart terminal is a Bluetooth media access control address of the second wearable smart terminal.

In contrast to the prior art, the present invention performs the operation of adding friends via the cloud. This could assist big data analysis. The user identification and the wearable smart terminal have a one-on-one correspondence such that the safety and reliability of friending another person could be improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a friending method of a wearable smart terminal according to a first embodiment of the present invention.

FIG. 2 is a flow chart of a friending method of a wearable smart terminal according to a second embodiment of the present invention.

FIG. 3 is a diagram showing a wearable smart terminal connecting to a cloud server according to a first embodiment of the present invention.

FIG. 4 is a diagram showing a wearable smart terminal connecting to a cloud server according to a second embodiment of the present invention.

FIG. 5 is a diagram showing a structure of a memory device according to an embodiment of the present invention.

### DETAILED DESCRIPTION OF PREFERRED EMBODIMENTS

For the purpose of description rather than limitation, the following provides such specific details as a specific system structure, interface, and technology for a thorough understanding of the application. However, it is understandable by persons skilled in the art that the application can also be implemented in other embodiments not providing such specific details. In other cases, details of a well-known apparatus, circuit and method are omitted to avoid hindering the description of the application by unnecessary details.

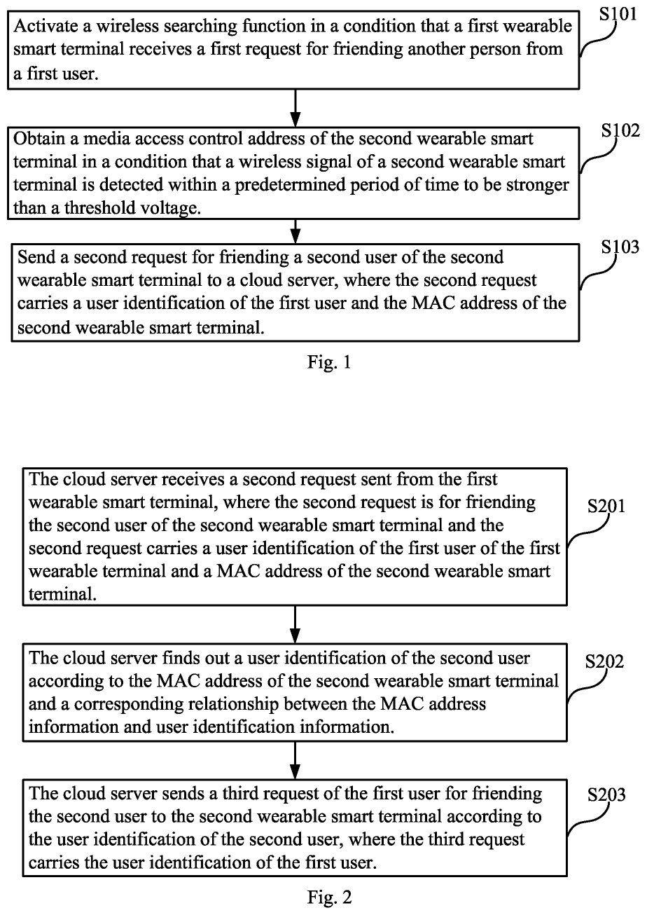

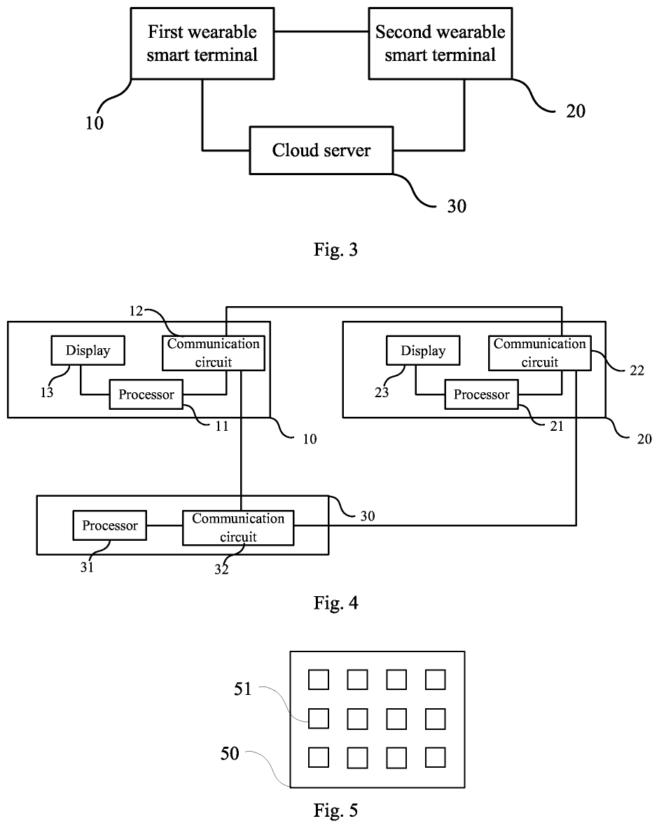

Please refer to FIG. 1 in conjunction with FIG. 3. FIG. 1 is a flow chart of a friending method of a wearable smart terminal according to a first embodiment of the present invention. FIG. 3 is a diagram showing the wearable smart terminal connecting to a cloud server according to an embodiment of the present invention. A friending method of the wearable smart terminal of a first embodiment of the present invention comprises the following steps:

Step 101: activating a wireless searching function in a condition that a first wearable smart terminal receives a first request for friending another person from a first user.

In the actual implementation, a local first user could open an embedded application of friending another person in the first wearable smart terminal 10 and thus enter the interface of friending another person. The first wearable smart terminal 10 receives a first request of friending another person from the first user and then automatically activates a Bluetooth signal searching function. In another embodiment, it can be Wifi, ZigBee, NFC, or other wireless communications. Bluetooth is only an example here, not a limitation.

Step 102: obtaining a media access control address of the second wearable smart terminal in a condition that a wireless signal of a second wearable smart terminal is detected within a predetermined period of time to be stronger than a threshold voltage.

In a preferred embodiment, the predetermined time period for the Bluetooth signal searching function is set as two minutes. In other embodiments, it could be set as one minute, three minutes, or five minutes. The threshold value is 45 decibels (dB). In other embodiments, it could be 40 dB, 50 dB, 60 dB or any other signal magnitudes. Here, if the first wearable smart terminal 10 could detect a Bluetooth signal greater than 45 dB within 2 minutes from a second wearable smart terminal 20, the first wearable smart terminal 10 could obtain a media access control (MAC) address of the second wearable smart terminal 20.

In another embodiment, in the condition that the first wearable smart terminal 10 cannot find any Bluetooth signal greater than 45 dB within 2 minutes, the first wearable smart terminal 10 displays a failure confirmation window such that the first user could confirms the failure information from the first wearable smart terminal 10. After the user clicks to confirm the failure information via this interface, the first user could activate the above-mentioned friending steps such that the first wearable smart terminal 10 could activate the searching function again. In another embodiment, in the condition that the first wearable smart terminal 10 cannot find any Bluetooth signal greater than 45 dB within 2 minutes, the first wearable smart terminal 10 could display a window of retrying the searching function after or at the time of displaying failure confirmation window. In this way, the first user could click the window of retrying the searching function and then the first wearable smart terminal 10 could immediately re-perform the above-mentioned friending steps.

Step 103: sending a second request for friending a second user of the second wearable smart terminal 20 to a cloud server, wherein the second request carries a user identification of the first user and the MAC address of the second wearable smart terminal 20.

In a preferred embodiment, after the first wearable smart terminal 10 detects the second wearable smart terminal 20 that meets its demand, the first wearable smart terminal 10 sends a request for friending the second user, who is solely corresponding to the second wearable smart terminal 20 (which means that the second wearable smart terminal 20 and the second user have one-on-one correspondence). The aforementioned request comprises a MAC address of the second wearable smart terminal 20 and a user identification of the first user, who is solely corresponding to the first wearable smart terminal 10 (which means that the first wearable smart terminal 10 and the first user have one-on-one correspondence).

In another embodiment, the second user of the second wearable smart terminal 20 accepts the request of the first user of the first wearable smart terminal 10 for friending the second user. Then, the second wearable smart terminal 20 sends another request for friending the first user of the first wearable smart terminal 10 to the cloud server 30.

Please refer to FIG. 2 in conjunction with FIG. 3. FIG. 2 is a flow chart of a friending method of a wearable smart terminal according to a second embodiment of the present invention. FIG. 3 is a diagram showing the wearable smart terminal connecting to a cloud server according to an embodiment of the present invention. A friending method of the wearable smart terminal of a second embodiment of the present invention comprises the following steps:

Step 201: The cloud server receives a second request sent from the first wearable smart terminal, where the second request is for friending the second user of the second wearable smart terminal and the second request carries a user identification of the first user of the first wearable terminal and a MAC address of the second wearable smart terminal.

In a preferred embodiment, the cloud server 30 receives a request of the first user, who is solely corresponding to the first wearable smart terminal 10, for friending the second user, who is solely corresponding to the second wearable smart terminal 20. The aforementioned request comprises a user identification of the first user and the MAC address of the second wearable smart terminal 20.

Step 202: The cloud server finds out a user identification of the second user according to the MAC address of the second wearable smart terminal and a corresponding relationship between the MAC address information and user identification information.

Because the user identification of a user and the wearable smart terminal have a one-on-one corresponding relationship, the user identification and the MAC address of the wearable smart terminal also have a one-on-one corresponding relationship. The corresponding relationship between the user identification and the MAC address of the wearable smart terminal had been stored in the cloud server 30 at the time when the user signed on. Therefore, the cloud server 30 could find out the user identification of the second user solely corresponding to the second wearable smart terminal 20 according to the MAC address of the second wearable smart terminal 20 after receiving the request sent from the first wearable smart terminal 10.

Step 203: The cloud server sends a third request of the first user for friending the second user to the second wearable smart terminal according to the user identification of the second user, where the third request carries the user identification of the first user.

The cloud server 30 sends a request of the first user for friending the second user through an extensible messaging and presence protocol (XMPP) to the second wearable smart terminal 20 according to the detected user identification of the second user, who is solely corresponding to the second wearable smart terminal 20. This request carries the user identification of the first user such that the second user could understand who would like to friend him.

In an embodiment of the present invention, the user identification and the wearable smart terminal have a one-on-one corresponding relationship and this corresponding relationship is stored in the cloud server. Therefore, the request for friending each other is sent by the cloud and this mechanism improves the big data statistics and also improves the safety and reliability of friending method because the user and the wearable smart terminal have a one-on-one corresponding relationship.

Please refer to FIG. 4, which is a diagram showing a wearable smart terminal connecting to a cloud server according to a second embodiment of the present invention. The first wearable smart terminal 10 comprises a processor 11, a communication circuit 12 and a display 13. The processor 11 is electrically coupled to the communication circuit 12 and the display 13. The second wearable smart terminal 20 has a similar structure as the first wearable smart terminal 10 and thus the related illustration is omitted here for simplicity. The cloud server 30 comprises a processor 31 and a communication circuit 32. The processor 31 is electrically coupled to the communication circuit 32.

In operation, the processor 21 of the second wearable smart terminal 20 controls the communication circuit 22 to send a wireless signal, which comprises the MAC address of the second wearable smart terminal 20. The processor 11 of the first wearable smart terminal 10 controls the communication circuit 12 to activate the wireless signal searching function. Then, the communication circuit 12 searches where there is a wireless signal stronger than a threshold value (such as 45 dB) within a predetermined period of time (such as two minutes). If a wireless signal sent by the communication circuit 22 is detected, the first wearable smart terminal 10 could obtain the MAC address of the second wearable smart terminal 20 from the wireless signal. The processor 11 controls the communication circuit 12 to link to the communication circuit 32 of the cloud server 30 and sends a request for friending the second user of the second wearable smart terminal 20. The aforementioned request comprises a user identification of the first user of the first wearable smart terminal 10 and the MAC address of the second wearable smart terminal 20.

After the communication circuit 32 of the cloud server 30 receives the aforementioned request sent by the first wearable smart terminal 10, the processor 31 seeks the user identification of the second user, who is solely corresponding to the second wearable smart terminal 20 according to the request and controls the communication circuit 32 to link to the communication circuit of the second wearable smart terminal 20 and to send a friending request of the first wearable smart terminal 10 to the second wearable smart terminal 20. This friending request comprises the user identification of the first user of the first wearable smart terminal 10.

After the second user of the second wearable smart terminal 20 accepts the friending request, the processor 21 controls the communication circuit 22 to send a friending request for friending the first user to the cloud server 30. The cloud server 30 receives the aforementioned request through the communication circuit 32 and then the processor 31 processes this request.

According to an embodiment of the present invention, the operation of friending each other is through the cloud. This mechanism improves the big data statistics and also improves the safety and reliability of friending method because the user identification and the wearable smart terminal have a one-on-one corresponding relationship.

Please refer to FIG. 5, which is a diagram showing a memory device according to an embodiment of the present invention. The memory device 50 stores at least a program instructions/commend 51. The program instructions/commend 51 is used to execute the friending method disclosed in FIG. 1 and FIG. 2. In a preferred embodiment, the memory device could be a storage chip, hard disk, flash drive, optical disk, removable hard disk, or any other memory device in a terminal or a server.

From the above, it could be understood that the program instructions stored in the memory device could be executed to perform the above-mentioned friending method of the wearable smart terminal such that a wearable smart terminal could friend another wearable smart terminal.

In contrast to the deficiency of social function in a conventional kids smart watch, an embodiment of the present invention improves the safety and reliability of friending each other by using one-on-one corresponding relationship between the user identification and the wearable smart terminal. In addition, the big data statistic is improved because the data are collected and stored through the cloud. Thus, a user's use adhesion to the watch could be increased.

Above are embodiments of the present invention, which does not limit the scope of the present invention. Any modifications, equivalent replacements or improvements within the spirit and principles of the embodiment described above should be covered by the protected scope of the invention.

1. A memory device storing program instructions executable by a processor to perform operations of:
in a condition that a first wearable smart terminal receives a first request for friending another person from a first user, activating a wireless searching function;
in a condition that a wireless signal of a second wearable smart terminal is detected within a predetermined period of time to be stronger than a threshold voltage, obtaining a media access control address of the second wearable smart terminal; and
sending a second request for friending a second user of the second wearable smart terminal to a cloud server to allow the cloud server to find a user identification of the second user according to a corresponding relationship between media access control address information and user identification information such that the cloud server further sends a third request of the first user for friending the second user, wherein the second request carries a user identification of the first user and the media access control address of the second wearable smart terminal and the third request carries a user identification of the first user,
wherein the wireless signal searching function is a Bluetooth signal searching function, and the media access control address of the second wearable smart terminal is a Bluetooth media access control address of the second wearable smart terminal.

2. The memory device of claim 1, wherein the operations further comprises:
receiving a fourth request of the second user for friending the first user from the cloud server.

3. The memory device of claim 1, wherein the operation of activating the wireless signal searching function comprises:
using the first wearable smart terminal to receive an activation commend to activate a friending instruction; and
in the condition that the first wearable smart terminal receives the first request via an interface of the friending instruction, activating the wireless signal searching function.

4. The memory device of claim 1, wherein the threshold value is 45 decibels (dB).

5. The memory device of claim 1, wherein the user identification of the first user and the first wearable smart terminal have a one-on-one correspondence, and the user identification of the second user and the second wearable smart terminal have a one-on-one correspondence.

6. A friending method of a wearable smart terminal, comprising:
in a condition that a first wearable smart terminal receives a first request for friending another person from a first user, activating a wireless searching function;
in a condition that a wireless signal of a second wearable smart terminal is detected within a predetermined period of time to be stronger than a threshold voltage, obtaining a media access control address of the second wearable smart terminal; and
sending a second request for friending a second user of the second wearable smart terminal to a cloud server to allow the cloud server to find a user identification of the second user according to a corresponding relationship between media access control address information and user identification information such that the cloud server further sends a third request of the first user for friending the second user, wherein the second request carries a user identification of the first user and the media access control address of the second wearable smart terminal and the third request carries a user identification of the first user.

7. The friending method of claim 6, further comprising:
receiving a fourth request of the second user for friending the first user from the cloud server.

8. The friending method of claim 6, further comprising:
if no wireless signal stronger than the threshold value is detected within the predetermined period of time, displaying a failure confirmation window to receive a confirmation information.

9. The friending method of claim 6, wherein the step of activating the wireless signal searching function comprises:
using the first wearable smart terminal to receive an activation commend to activate a friending instruction; and
in the condition that the first wearable smart terminal receives the first request via an interface of the friending instruction, activating the wireless signal searching function.

10. The friending method of claim 6, wherein the wireless signal searching function is a Bluetooth signal searching function, and the media access control address of the second wearable smart terminal is a Bluetooth media access control address of the second wearable smart terminal.

11. The friending method of claim 6, wherein the threshold value is 45 decibels (dB).

12. The friending method of claim 6, wherein the user identification of the first user and the first wearable smart terminal have a one-on-one correspondence, and the user identification of the second user and the second wearable smart terminal have a one-on-one correspondence.

13. A wearable smart terminal, comprising a processor, communication circuit, and a display; wherein the processor is electrically coupled to the communication circuit and the display, the processor controls itself, the communication circuit and the display to perform operations of:
in a condition that a first wearable smart terminal receives a first request for friending another person from a first user, activating a wireless searching function;
in a condition that a wireless signal of a second wearable smart terminal is detected within a predetermined period of time to be stronger than a threshold voltage, obtaining a media access control address of the second wearable smart terminal; and
sending a second request for friending a second user of the second wearable smart terminal to a cloud server to allow the cloud server to find a user identification of the second user according to a corresponding relationship between media access control address information and user identification information such that the cloud server further sends a third request of the first user for friending the second user, wherein the second request carries a user identification of the first user and the media access control address of the second wearable smart terminal and the third request carries a user identification of the first user.

14. The wearable smart terminal of claim 13, wherein the operations further comprise:
receiving a fourth request of the second user for friending the first user from the cloud server.

15. The wearable smart terminal of claim 13, wherein the operations further comprise:
if no wireless signal stronger than the threshold value is detected within the predetermined period of time, displaying a failure confirmation window to receive a confirmation information.

16. The wearable smart terminal of claim 13, wherein the operation of activating the wireless signal searching function comprises:
using the first wearable smart terminal to receive an activation commend to activate a friending instruction; and
in the condition that the first wearable smart terminal receives the first request via an interface of the friending instruction, activating the wireless signal searching function.

17. The wearable smart terminal of claim 13, wherein the wireless signal searching function is a Bluetooth signal searching function, and the media access control address of the second wearable smart terminal is a Bluetooth media access control address of the second wearable smart terminal.

18. The wearable smart terminal of claim 6, wherein the threshold value is 45 decibels (dB).

19. The wearable smart terminal of claim 13, wherein the user identification of the first user and the first wearable smart terminal have a one-on-one correspondence, and the user identification of the second user and the second wearable smart terminal have a one-on-one correspondence.
